(19) United States
(12) Patent Application Publication
(10) Pub. No.: US 2016/0094645 A1
(43) Pub. Date: Mar. 31, 2016

(54) DNS-BASED LOAD BALANCING

(71) Applicant: Microsoft Corporation, Redmond, WA (US)

(72) Inventors: Kumar Ashutosh, Hyderabad (IN); Vithalprasad Jayendra Gaitonde, Hyderabad (IN); Tushar Gupta, Hyderabad (IN); Sourav Sain, Hyderabad (IN); Ashray Mahodaya, Hyderabad (IN); Abhijeet Kumar, Hyderabad (IN); Neeraj Motwani, Hyderabad (IN); Srikanth Kumar Kovuri Rajaiah, Hyderabad (IN)

(21) Appl. No.: 14/498,585

(22) Filed: Sep. 26, 2014

(51) Int. Cl. H04L 29/08; H04L 29/12

(52) U.S. Cl. CPC H04L 67/1036; H04L 67/1029; H04L 61/103; H04L 61/1552

(57) ABSTRACT

A Domain Name System (DNS) server that is operable to apply DNS-based load balancing policies based on geolocation and time of day is described herein. In an embodiment, the DNS server determines a geolocation and a time of day associated with a plurality of DNS queries and then obtains a domain name resolution policy that is associated with one or more of the geolocation and the time of day. The policy specifies a plurality of geographically disparate data centers and a ratio by which domain names are to be resolved thereto. The ratio at least specifies that more domain names are to be resolved to one of the plurality of geographically disparate data centers than another. The DNS server applies the domain name resolution policy to resolve the domain names in the DNS queries.

### BACKGROUND

Some cloud service providers operate their online services out of multiple data centers that are located in different geographical areas. In order to provide the best response time to users, Domain Name System (DNS) policies may be implemented by or on behalf of such cloud service providers so that users from a particular geographical region (e.g., the United States) will be directed to the data center which is closest to them (e.g., North America). These DNS policies, which may be referred to as geo-location aware DNS policies, may be implemented by controlling a DNS server's response to domain name resolution requests to depend on the geographic location of the client sending the domain name resolution request. However, there are times of day when a specific data center may be more heavily loaded. For example, it may be likely that a data center located in North America will be heavily loaded between 10 A.M. and 12 Noon Pacific Standard Time (PST) and it will be suboptimal if all users in the United States are directed to the North America data center during this time period.

### SUMMARY

A DNS server that is operable to apply DNS-based load balancing policies based on geolocation and time of day is described herein. In accordance with embodiments, a plurality of DNS queries are received by the DNS server. The DNS server determines both a geolocation and a time of day associated with the plurality of DNS queries and then obtains a domain name resolution policy that is associated with one or more of the geolocation and the time of day. The domain name resolution policy specifies a plurality of geographically disparate data centers and a ratio by which domain names are to be resolved to the plurality of geographically disparate data centers. The ratio at least specifies that more domain names are to be resolved to one of the plurality of geographically disparate data centers than another. The DNS server applies the domain name resolution policy to resolve the domain names in the DNS queries. An application programming interface (API) by which such domain name resolution policies may be configured is also described.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the claimed subject matter is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a block diagram of a system in which DNS-based load balancing is used to manage a number of connections made between a plurality of client computing devices and a plurality of geographically-disparate data centers in accordance with an embodiment.

FIG. 2 is a block diagram of a DNS server in accordance with an embodiment.

FIG. 3 depicts a flowchart of a method for performing DNS-based load balancing in accordance with an embodiment.

FIG. 4 depicts a flowchart of a method for implementing a domain name resolution policy in accordance with an embodiment.

FIG. 5 depicts a flowchart of a method for specifying a domain name resolution policy in accordance with an embodiment.

FIG. 6 is a block diagram of an example processor-based computer system that may be used to implement various embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

A DNS server that is operable to apply DNS-based load balancing policies based on geolocation and time of day is described herein. In accordance with embodiments, a plurality of DNS queries are received by the DNS server. The DNS server determines both a geolocation and a time of day associated with the plurality of DNS queries and then obtains a domain name resolution policy that is associated with one or more of the geolocation and the time of day. The domain name resolution policy specifies a plurality of geographically disparate data centers and a ratio by which domain names are to be resolved to the plurality of geographically disparate data centers. The ratio at least specifies that more domain names are to be resolved to one of the plurality of geographically disparate data centers than another. The DNS server applies the domain name resolution policy to resolve the domain names in the DNS queries. An application programming interface (API) by which such domain name resolution policies may be defined is also described.

Section II describes a DNS server that provides the aforementioned features and a system that includes the same. Section III describes an example processor-based computer system that may be used to implement various embodiments described herein. Section IV describes some additional exemplary embodiments. Section V provides some concluding remarks.

### II. Example DNS Server that Implements DNS-Based Load Balancing and System Including Same

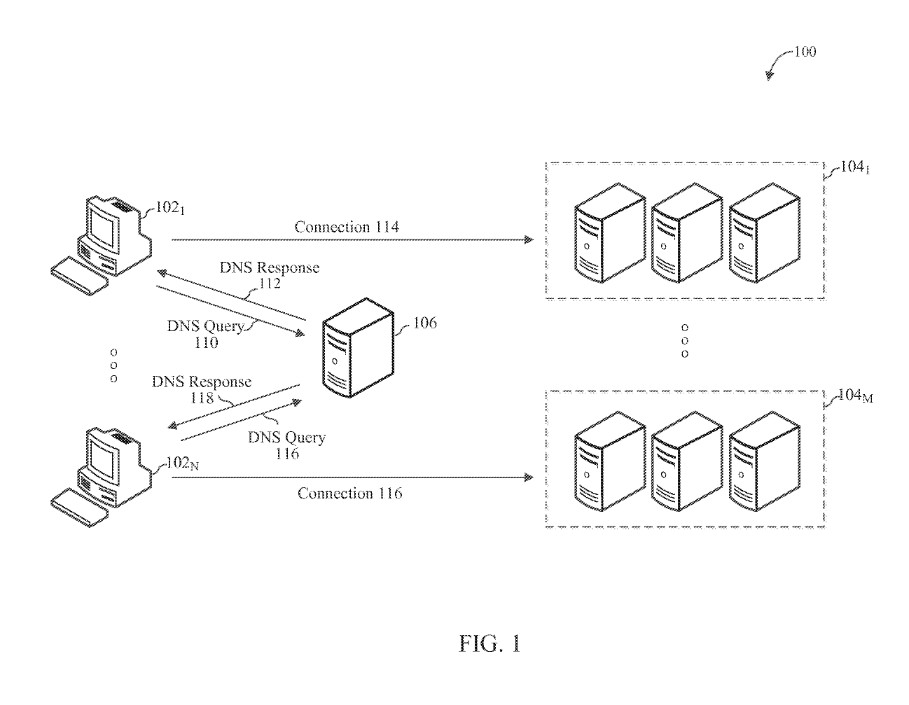

FIG. 1 is a block diagram of an example system 100 in which DNS-based load balancing is used to manage a number of network connections made between a plurality of client computing devices 102₁-102_{N} and a plurality of geographically-disparate data centers 104₁-104_{M}. As shown in FIG. 1, system 100 includes the plurality of client computing devices 102₁-102_{N}, the plurality of geographically disparate datacenters 104₁-104_{M}, and at least one DNS server 106.

Each of client computing devices 102₁-102_{N} is intended to represent a processor-based electronic device that is configured to execute software for accessing applications, services, or other resources hosted on remote machines (e.g., any of the machines located in data centers 104₁-104_{M}) via a network. Such software may include, for example and without limitation, a Web-browser or any other application that is designed to access resources via the Internet. Furthermore, each of client computing devices 102₁-102_{N} is configured to execute software that facilitates such access by sending DNS queries to a DNS server (e.g., DNS server 106) for the purpose of resolving domain names of resources to Internet Protocol (IP) addresses of the machines that host them. Client computing devices 102₁-102_{N} may include, for example and without limitation, at least one mobile computing device such as a mobile phone (e.g., a smart phone), a laptop computer, a tablet computer, a netbook, a wearable computer such as a smart watch or a head-mounted computer, a portable media player, a handheld gaming console, or the like. Client computing devices 102₁-102_{N} may also include, for example and without limitation, at least one desktop computer, gaming console, or other non-mobile computing platform.

Each of data centers 104₁-104_{M} is intended to represent a facility used to house computer systems and associated components, such as telecommunications and storage systems. As shown in FIG. 1, each of data centers 104₁-104_{M} comprises a set of one or more machines (e.g., physical and/or virtual machines), each of which is capable of hosting an application, service or other resource that can be accessed via a network by software executing on one or more remote computing devices (e.g., any of client computing devices 102₁-102_{N}). In an embodiment, each of data centers 104₁-104_{M} is located in a different geographical area than each other one of data centers 104₁-104_{M}. For example, one of data centers 104₁-104_{M} may be located in North America, while another may be located in Europe, and another may be located in Asia. As another example, each of data centers 104₁-104_{M} may be located in a different state or region of the same country. As yet another example, each of data centers 104₁-104_{M} may be located in a different time zone. Still other forms of geographic disparity than those mentioned above may be encompassed by the term “different geographical area.”

DNS server 106 is intended to represent software executing on a machine (e.g., a physical or virtual machine) to which any of client computing devices 102₁-102_{N} may connect via a network, such as but not limited to the Internet. DNS server 106 is configured to receive DNS queries from each of client computing devices 102₁-102_{N}. A DNS query may include a domain name of a resource for which resolution is sought. For each such DNS query, DNS server 106 operates to translate the domain name included therein to an IP address of a particular machine included in one of data centers 104₁-104_{M} and to return the IP address as part of a DNS response to the particular client computing device that sent the DNS query. The client computing device can then use the IP address to access a remote application, service or other resource that is hosted on the machine identified thereby via a network, such as but not limited to the Internet.

By way of example, an application executing on client computing device 102₁ may be tasked with accessing a resource identified by the domain name “mail.contoso.com”. If client computing device 102₁ is unable to resolve the domain name locally (e.g., by accessing a local DNS cache), then client computing device 102₁ will send a DNS query 110 to DNS server 106 that includes the domain name “mail.contoso.com”. In response to receiving DNS query 110, DNS server 106 translates the domain name “mail.contoso.com” included therein to an IP address of a machine within one of data centers 104₁-104_{N} that hosts the resource identified by that domain name. In this example, we will assume that DNS server 106 translates the domain name “mail.contoso.com” to an IP address of a machine within data center 104₁. DNS server 106 then returns the IP address as part of DNS response 112 to client computing device 102₁. Client computing device 102₁ establishes a connection 114 to the machine within data center 104₁ that is identified by the IP address included in DNS response 112. Client computing device 102₁ then uses connection 114 to access the resource hosted on that machine.

Since different machines may host different instances of the same resource, DNS server 106 may be configured to resolve the same domain name to different IP addresses. For example, client computing device 102_{N} may send a DNS query 116 to DNS server 106 that also includes the domain name “mail.contoso.com”. In response to receiving DNS query 116, DNS server 106 may translate the domain name “mail.contoso.com” included therein to an IP address of a machine within data center 104_{M}. DNS server 106 then returns the IP address as part of DNS response 118 to client computing device 102_{N}. Client computing device 102_{N} establishes a connection 116 to the machine within data center 104_{M} that is identified by the IP address included in DNS response 118. Client computing device 102_{N} then uses connection 116 to access the resource hosted on that machine.

Thus, when different instances of the same resource are hosted on different machines in different data centers, DNS server 106 can manage traffic to those data centers by managing how it resolves the resource's domain name. That is to say, DNS server 106 can perform load balancing among geographically-disparate disparate data centers 104₁-104_{M}. For example, to increase the load on a particular data center, DNS server 106 can increase the number of instances of a particular domain name that are resolved to IP addresses of machines in that data center. Conversely, to decrease the load on a particular data center, DNS server 106 can reduce the number of instances of the particular domain name that are resolved to IP addresses of machines in that data center.

In embodiments, DNS server 106 is configured to perform domain name resolution in accordance with one or more user-defined domain name resolution policies. Such domain name resolution policies may specify, for example, that a particular domain name is to be resolved to machines in a particular data center 104₁-104_{M} based on one or more factors.

By way of example, a domain name resolution policy implemented by DNS server 106 may specify that domain names in DNS queries originating from client computing devices from a particular geographic area to be resolved to machines in a data center that is closest to that geographic area. Thus, for example, a domain name resolution policy implemented by DNS server 106 may specify that when the domain name “mail.contoso.com” appears in DNS queries originating from client computing devices in the U.S.A., such domain name is to be resolved to a data center located in North America, while another domain name resolution policy implemented by DNS server 106 may specify that when the domain name “mail.contoso.com” appears in DNS queries originating from client computing devices in China, such domain name is to be resolved to a data center located in Asia. Such a domain name resolution policy may be referred to as a geo-location aware domain name resolution policy. A geo-location aware domain name resolution policy may improve response times for users of client computing devices 102₁-102_{N} by directing resource requests to the nearest data center 104₁-104_{M}.

However, there may be times of day when a particular one of data centers 104₁-104_{M} may be more heavily loaded than another. For example, assume that a data center located in North America is likely to be heavily loaded between 10 A.M. and 12 Noon Pacific Standard Time (PST). In view of this, it may be suboptimal if all requests for a particular resource that originate in North America are directed to the North American data center during this time period. However, further assume that at this time of day, a data center in Europe that hosts the same resource is likely to be less loaded. In this case, a provider of the resource may be able to provide a better response time to users in North America if some portion of the resource requests originating from North America (e.g., 20% of the resource requests) could be directed to the European data center rather than the North American data center.

To help achieve this, in accordance with an embodiment, DNS server 106 is capable of implementing a domain name resolution policy that takes into account both time of day and the geolocation of the client computing device from which a resource request originates. Furthermore, to provide for more fine-tuned load balancing, DNS server 106 is capable of implementing a domain name resolution policy that specifies both a plurality of geographically disparate data centers (e.g., two or more of data centers 104₁-104_{1M}) and a ratio by which domain names are to be resolved to the plurality of geographically disparate data centers. Thus, for example, DNS server 106 is capable of implementing a domain name resolution policy that specifies that between the hours of 10 A.M and 12 Noon PST, for all the domain name resolution requests originating from North America for which the domain name zone “contoso.com” is authoritative, 60% of such requests such be resolved to a data center in North America, 20% of such requests should be resolved to a data center in Europe, and 20% should be resolved to a data center in Asia. This is only one example, however, and a wide variety of other domain name resolution policies may be implemented by DNS server 106 that take into account time of day, geolocation of the origin of the resource request, and other factors and/or that specify other load balancing ratios.

It is noted that although FIG. 1 shows only a single DNS server 106, in embodiments, system 100 may comprise a plurality of DNS servers, each of which is configured to perform DNS-based load balancing in a manner described herein. Furthermore, in FIG. 1, all DNS queries sent to DNS server 106 are shown as being received directly from a client computing device. However, as will be appreciated by persons skilled in the art, a DNS query can also be forwarded to DNS server 106 from another DNS server as part of a process called recursion.

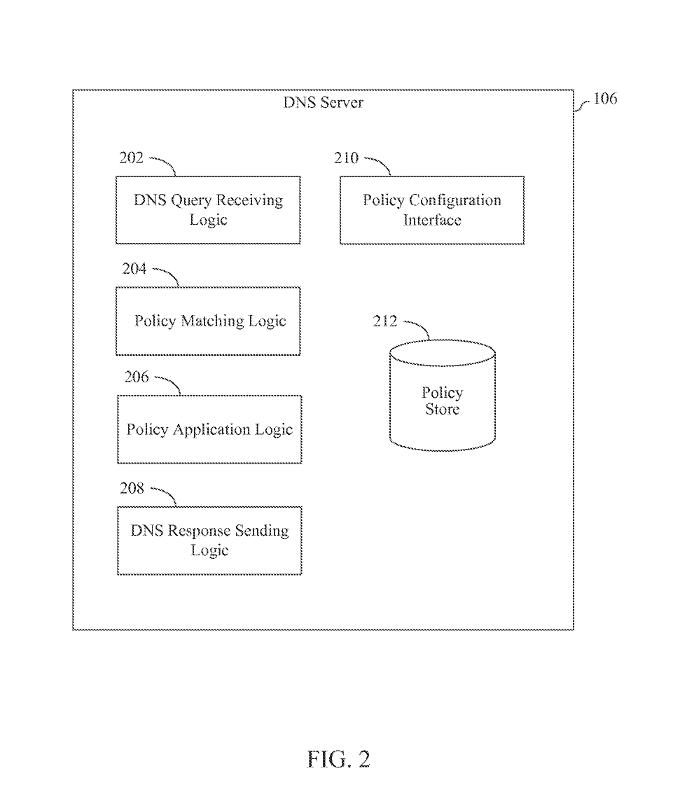

An example implementation of DNS server 106 will now be further described in reference to the block diagram of FIG. 2. As shown in FIG. 2, in one embodiment, DNS server 106 comprises DNS query receiving logic 202, policy matching logic 204, policy application logic 206, DNS response sending logic 208, policy configuration interface 210, and a policy store 212. Each of these components will now be described.

DNS query receiving logic 202 comprises logic that operates to receive DNS queries from client computing devices (e.g., any of client computing devices 102₁-102_{N}) or from other DNS servers. DNS query receiving logic 202 may operate to receive a DNS query encapsulated (e.g., as a payload) within a User Datagram Protocol (UDP) or Transmission Control Protocol (TCP) packet transmitted over an Internet Protocol (IP) network.

Policy matching logic 204 comprises logic that operates to determine, for each DNS query received by DNS query receiving logic 202, whether any domain name resolution policies stored in policy store 214 should be applied to the DNS query. Policy matching logic 204 may make this determination based on a variety of information, including but not limited to: (1) the geolocation of the client computing device from which the DNS query originated; (2) the time of day at which the DNS query was received (e.g., the time of day that the DNS query was incident on DNS server 106); (3) a Fully Qualified Domain Name (FQDN) included in the DNS query and for which resolution is sought; (4) the Transport Protocol used to send the DNS query (e.g., UDP vs. TCP); (5) the Internet Protocol used to send the DNS query (e.g., IPV4 or IPV6); (6) the network interface upon which the DNS query was received (e.g., if the physical host of DNS server 106 has multiple network interfaces, such as 10.0.1 vs. 10.0.2); and (7) the query type (QTYPE) in the DNS query (e.g, A, AAAA, etc.).

To determine the geolocation of the client computing device from which the DNS query originated, policy matching logic 204 may compare a source IP address included in a transport layer packet (e.g., UDP or TCP packet) that encapsulates the DNS query to one or more IP address subnets that map to a particular geographical location. If the source IP address is within one of the IP address subnets, then the client computing device will be determined to be in the particular geographical location. In another embodiment, a client-server level agreement may be utilized to enable a client computing device to send geolocation information to DNS server 106 via an optional DNS communication. However, these are only examples, and still other approaches may be used to determine the geolocation of the client computing device from which the DNS query originated.

If policy matching logic 204 determines that a domain name resolution policy stored in policy store 214 should be applied to a DNS query, then policy application logic 206 will operate to apply the policy to the DNS query. Depending upon the policy, this may involve taking one of a variety of different actions with respect to resolving a domain name included in the DNS query. For example, a policy might specify that the domain name included in the DNS query should be resolved to a particular one of data centers 104₁-104_{M} (i.e., resolved to an IP address of a machine within a particular one of data centers 104₁-104_{M}). As another example, a policy might specify that the domain name included in the DNS query should be resolved to one of data centers 104₁-104_{M} as determined by a ratio or other distribution scheme set forth in the policy. Such a policy might specify, for example, that as between a first and second data center, a ratio of 3:1 should be used for resolving domain names in DNS queries subject to the policy. In this case, policy application logic 206 would operate to ensure that for every three domain names that are resolved to the first data center in accordance with the policy, a single domain name is resolved to the second data center.

DNS response sending logic 208 comprises logic that constructs a DNS response for each DNS query received by DNS query receiving logic 202 and that sends each DNS response to the entity from which the corresponding DNS query was received (e.g., any of client computing devices 102₁-102_{N} or another DNS server). To generate the DNS response, DNS response sending logic 208 may include therein an IP address therein to which a domain name included in the corresponding DNS query was resolved by policy application logic 206. Sending the DNS response may include encapsulating the DNS response (i.e., including it as a payload) within a UDP or TCP packet and then transmitting the UDP/TCP packet over an IP network.

Policy configuration interface 210 comprises an interface that enables an administrator or other user to specify domain name resolution policies for inclusion in policy store 212 and application by policy application logic 206. In an embodiment, policy configuration interface 210 comprises an application programming interface (API) that enables other programs (e.g. programs executing on the same machine as DNS server 106 or on a different machine) to communicate with domain name server 106 for the purpose of specifying domain name resolution policies. For example, an administrator or other user may utilize a remote procedure call (RPC) API to convey domain resolution policies from a remote machine to DNS server 106. Alternatively, policy configuration interface 210 may comprise a user interface (e.g. a command line interface, a graphical user interface, or the like) with which a user may interact directly with DNS server 106 to specify domain name resolution policies.

Domain name resolution polices received by or otherwise generated through interaction with policy configuration interface 210 are stored thereby in policy store 212. Policy store 212 may comprise a data structure, database, or other form of data storage implemented in volatile and/or non-volatile memory. In one embodiment, policy store 212 comprises part of an operating system registry that is persistently stored by a machine upon which DNS server 106 is executed. Additionally, policy store 212 may also comprise part of a process associated with DNS server 106 during execution thereof.

Specifying a domain name resolution policy via policy configuration interface 210 may comprise specifying the set of DNS queries to which the policy should be applied. This may involve specifying certain features associated with DNS queries. Those DNS queries that have the specified features will be subject to the policy while those DNS queries that do not have the specified features will not be subject to the policy. The features may include but are not limited to: (1) a geolocation of the client computing device from which the DNS query originated; (2) a time of day at which the DNS query was received (e.g., the time of day that the DNS query was incident on DNS server 106); (3) a Fully Qualified Domain Name (FQDN) included in the DNS query and for which resolution is sought; (4) a Transport Protocol used to send the DNS query (e.g., UDP vs. TCP); (5) an Internet Protocol used to send the DNS query (e.g., IPV4 or IPV6); (6) a network interface upon which the DNS query was received (e.g., if the physical host of DNS server 106 has multiple network interfaces, such as 10.0.1 vs. 10.0.2); and (7) a query type (QTYPE) in the DNS query (e.g, A, AAAA, etc.).

Specifying a domain name resolution policy via policy configuration interface 210 may further comprise specifying how domain names included in DNS queries to which the policy is applied should be resolved. For example, specifying the domain name resolution policy may comprise specifying that domain names included in DNS queries to which the policy is applied should be resolved to a particular one of data centers 104₁-104_{M} (i.e., resolved to an IP address of a machine within a particular one of data centers 104₁-104_{M}). As another example, specifying the domain name resolution policy may comprise specifying that domain names included in DNS queries to which the policy is applied should be resolved to different ones of data centers 104₁-104_{M} in accordance with a ratio or other distribution scheme. For example, it may be specified that as between a first and second data center, a ratio of 3:1 should be used for resolving domain names in DNS queries subject to the policy. A ratio may be specified between any number of data centers.

An example method signature that may be used to add a domain name resolution policy via policy configuration interface 210 will now be provided. The domain name resolution policy defined by the method signature takes into account geolocation and time of day and also resolves DNS queries among geographically-disparate data centers based on a ratio.

Define var America = 10.0.0.1/24; 20.0.0.1/24; 2001 : db8 : : / 48
Method Add-DnsServerNameResolutionPolicy
{
Name:- Sample
Zone: - contoso.com
TimeOfDay:- 10:00-14:00
ClientSubnet:- var America
Scope:- {Datacenter1,1}; {Datacenter2,3}; {Datacenter3,5};
}

In the foregoing example method signature, the define statement defines a variable “America” that contains a list of IP address subnets that map to the geographical location America. Also, in the foregoing example method signature, the method creates a domain name resolution policy named “Sample” on DNS server 106. In accordance with the domain name resolution policy “Sample,” all DNS queries for which zone “contoso.com” is authoritative, coming from IP ranges as defined in “America,” when incident on DNS server 106 between time 10:00-14:00 of the day, are responded to from the geographically disparate data centers “datacenter1,” “datacenter2” and “datacenter3” in the ratio 1:3:5. The “Scopes” are a logical partition of contoso.com such that DNS records in a scope point to machines in a particular data center.

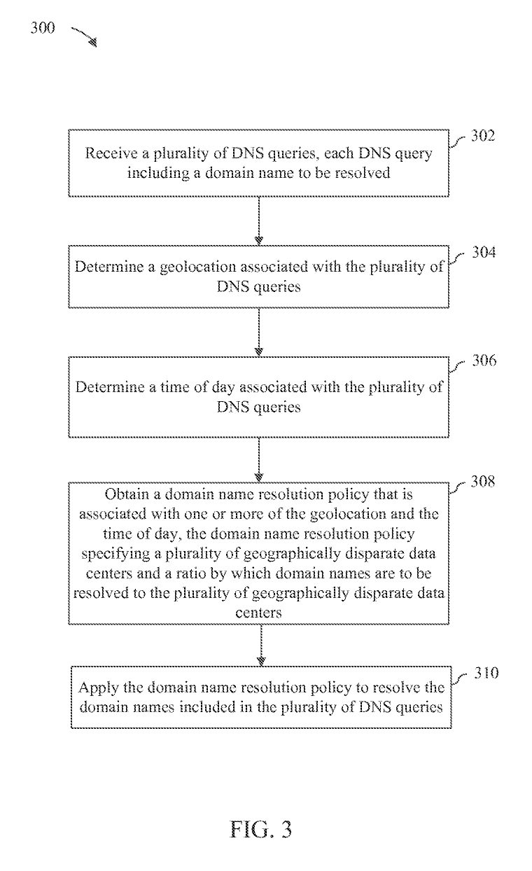

The foregoing load-balancing techniques will now be further illustrated with respect to FIG. 3. In particular, FIG. 3 depicts a flowchart 300 of a method for performing DNS-based load balancing. The method of flowchart 300 may be performed, for example, by DNS server 106. Although the method will now be described with continued reference to DNS server 106, persons skilled in the art will appreciate that the method of flowchart 300 is not limited to that embodiment.

As shown in FIG. 3, the method of flowchart 302 begins at step 302 in which a plurality of DNS queries is received. This step may be performed, for example, by DNS query receiving logic 202. The plurality of DNS queries may be received from client computing devices (e.g., any of client computing devices 102₁-102_{N}) or from other DNS servers. Each DNS query that is received during step 302 may comprise part (e.g., a payload) of a UDP or TCP packet that is transmitted over an IP network.

At step 304, a geolocation associated with the plurality of DNS queries received during step 302 is determined. This step may be performed, for example, by policy matching logic 204. Determining the geolocation associated with the plurality of DNS queries may comprise, for example, performing the following for each DNS query: determining a source IP address of a UDP or TCP packet that encapsulates the DNS query and then determining that the source IP address is contained within a set of IP addresses (e.g., a list of IP address subnets) that are associated with the geolocation. Alternatively, this step may comprise obtaining geolocation information from a source of the DNS query (e.g., any of client computing devices 102₁-102_{N} or another DNS server). Such geolocation information may be provided, for example, via an optional DNS communication arranged via a client-server level agreement. Still other methods may be used to determine the geolocation associated with the plurality of DNS queries.

At step 306, a time of day associated with the plurality of DNS queries received during step 302 is determined. This step may be performed, for example, by policy matching logic 204. Determining the time of day associated with the plurality of DNS queries may comprise, for example, performing the following for each DNS query: determining a time of day that the DNS query was incident upon the DNS server. Still other methods may be used to determine the time of day associated with the plurality of DNS queries.

At step 308, a domain name resolution policy that is associated with one or more of the geolocation determined during step 304 and the time of day determined during step 306 is obtained. This step may be performed, for example, by policy matching logic 204, which operates to obtain a domain name resolution policy from policy store 212 that is associated with one or more of the geolocation determined during step 304 and the time of day determined during step 306.

For example, with continued reference to the example domain name resolution policy “Sample,” described above, policy matching logic 204 may determine that that each DNS query in the plurality of DNS queries originates from the geographical area “America” (i.e., is associated with the geographical area “America”) and that each DNS query in the plurality of DNS queries was received during the time of day 10:00-14:00 (i.e., is associated with the time of day 10:00-14:00). Based on these factors (as well as on the fact that the zone “contoso.com” is authoritative for the DNS queries), policy matching logic 204 obtains the domain name resolution policy “Sample” from policy store 212.

As was previously described, obtaining the domain name resolution policy that is associated with at least the geolocation and the time of day may comprise obtaining a domain name resolution policy that is associated with one or more of the geolocation and the time of day, as well as one or more of: a Fully Qualified Domain Name; a Transport Protocol; an Internet Protocol; a server network interface; and a query type.

As shown in step 308, the obtained domain name resolution policy specifies a plurality of geographic disparate data centers and a ratio by which domain names are to be resolved to the plurality of geographically disparate data centers. In an embodiment, the ratio at least specifies that more domain names are to be resolved to one of the plurality of geographically disparate data centers than another. For example, with continued reference to the example domain name resolution policy “Sample,” the policy specifies the plurality of geographically disparate data centers “Datacenter1,” “Datacenter2,” and “Datacenter3” and the ratio “1:3:5” by which domain names are to be resolved to those data centers, respectively. In this example, more domain names are to be resolved to data center “Datacenter3” than to data center “Datacenter2,” and more domain names are to be resolved to data center “Datacenter2” than to data center “Datacenter1.”

At step 310, the domain name resolution policy obtained during step 308 is applied to resolve the domain names included in the plurality of DNS queries. This step may be performed, for example, by policy matching logic 204. Resolving the domain names included in the plurality of DNS queries may comprise resolving each of the domain names included in the plurality of DNS queries to an IP address associated with one of the plurality of geographically disparate data centers (e.g., to an IP address of a machine located in one of the plurality of geographically disparate data centers). Depending upon the policy, this step may involve, for example, resolving all of the domain names included in the plurality of DNS queries to a particular data center, or to a plurality of data centers in accordance with a specified ratio or other distribution metric.

The method of flowchart 300 may further include a step of sending DNS responses to each of the plurality of DNS queries. This step may be performed, for example, by DNS response sending logic 208. Each DNS response sent during this step may include the IP address to which the domain name included in the corresponding DNS query was resolved.

The method of flowchart 300 may also include a step of receiving the domain name resolution policy via a policy configuration interface, such as policy configuration interface 210, and storing the domain name resolution policy in a policy store, such as policy store 212. In an embodiment, storing the domain name resolution policy in policy store 212 may comprise storing the domain name resolution policy in a data structure of a process associated with DNS server 106 and/or storing the domain name resolution policy in an operating system registry or other data store that is persistently stored by the processor-based computing device upon which DNS server 106 is executing.

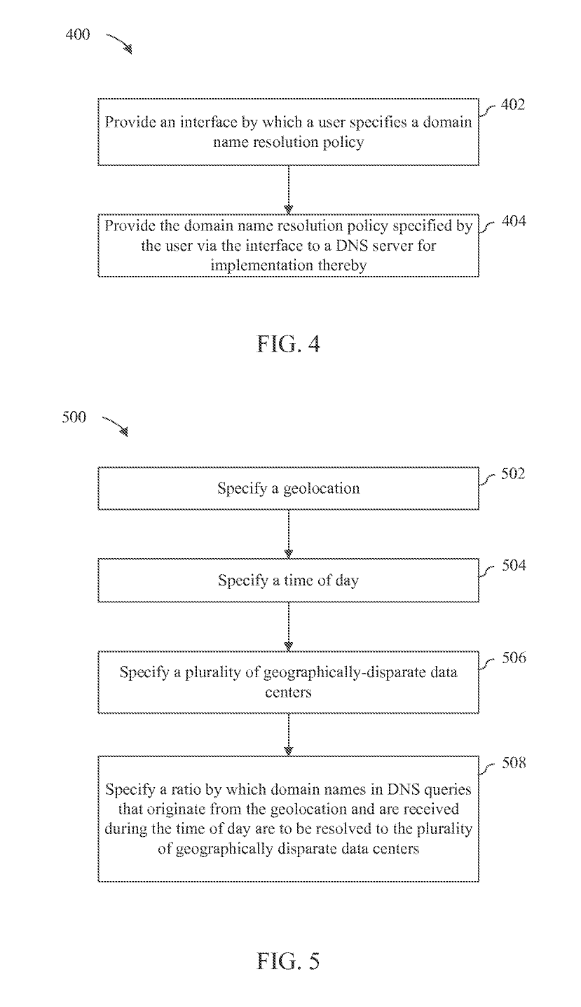

One manner in which domain name resolution policies may be implemented by a DNS server in accordance with an embodiment will now be illustrated in reference to FIG. 4. In particular, FIG. 4 depicts a flowchart 400 of a method for implementing a DNS name resolution policy. The method of flowchart 400 may be implemented, for example, by DNS server 106 of FIGS. 1 and 2. However, the method is not limited to that embodiment.

As shown in FIG. 4, the method of flowchart 400 begins at step 402, in which an interface is provided by which a user (e.g., a system administrator or other user) specifies a domain name resolution policy. For example, DNS server 106 may provide policy configuration interface 210 by which a user specifies a domain name resolution policy. As discussed above, policy configuration interface 210 may comprise an API by which other programs may communicate with DNS server 106 for the purpose of defining a domain name resolution policy or a user interface by which a user may interact directly with DNS server 106 for the purpose of defining a domain name resolution policy.

At step 404, the domain name resolution policy specified by the use via the interface is provided to a DNS server for implementation thereby. For example, policy configuration interface 210 may provide the specified domain name resolution policy for storage in policy store 212 and subsequent application to DNS queries by policy application logic 206.

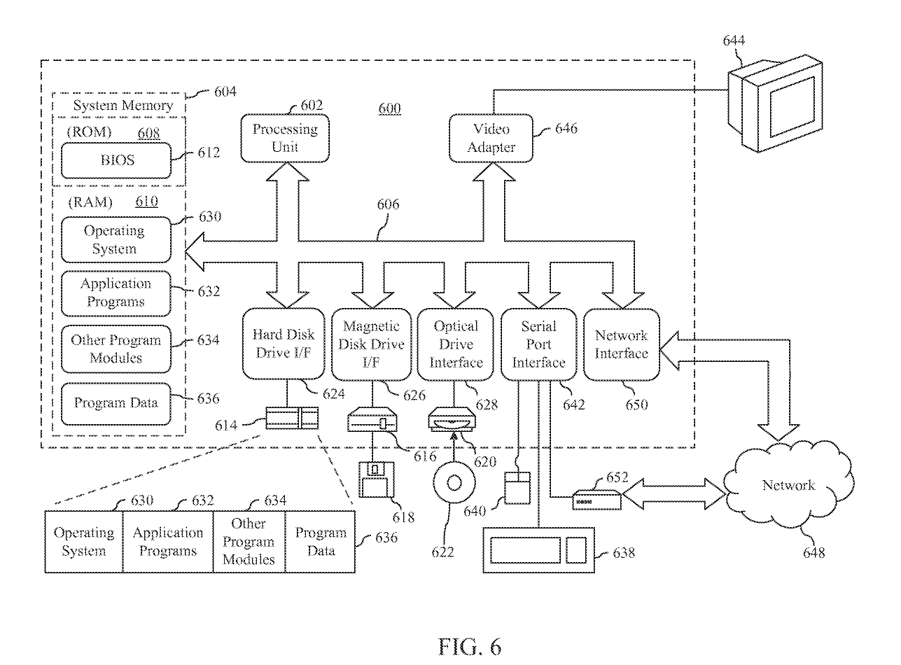

FIG. 5 depicts a flowchart 500 of a method by which a user may specify a domain name resolution policy in accordance with an embodiment. The method of flowchart 500 may be performed, for example, via programmatic or user interaction with policy configuration interface 210 of DNS server 106, although the method is not limited to that implementation.

As shown in FIG. 5, the method of flowchart 500 begins at step 502, in which the user specifies a geolocation. The geolocation may comprise a geographic region or area from which DNS queries may be received. In one embodiment, the geolocation may be defined as encompassing a set of IP addresses (e.g., a list of IP address subnets) from which such DNS queries may be received, although other techniques for specifying a geolocation may be used.

At step 504, the user specifies a time of day. The time of day may comprise a particular time period or set of time periods during which DNS queries may be received. In one embodiment, the time of day may be defined as encompassing a time period or set of time periods during which such DNS queries may be incident on a DNS server, such as DNS server 106.

At step 506, the user specifies a plurality of geographically-disparate data centers, such as any two or more of data centers 104₁-104_{M}.

At step 508, the user specifies a ratio by which domain names in DNS queries that originate from the geolocation specified in step 502 and are received during the time of day specified during step 504 are to be resolved to the plurality of geographically disparate data centers. In an embodiment, the ratio at least specifies that more domain names are to be resolved to one of the plurality of geographically disparate data centers than another.

### III. Example Computer System Implementation

FIG. 6 depicts an example processor-based computer system 600 that may be used to implement various embodiments described herein. For example, computer system 600 may be used to implement DNS server 106, any of client computing devices 102₁-102_{M}, or any of the machines in data centers 104₁-104_{M}, as described above. Computer system 600 may also be used to implement any or all of the steps of any or all of the flowcharts depicted in FIGS. 3-5. The description of computer system 600 is provided herein for purposes of illustration, and is not intended to be limiting. Embodiments may be implemented in further types of computer systems, as would be known to persons skilled in the relevant art(s).

As shown in FIG. 6, computer system 600 includes a processing unit 602, a system memory 604, and a bus 606 that couples various system components including system memory 604 to processing unit 602. Processing unit 602 may comprise one or more microprocessors or microprocessor cores. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random access memory (RAM) 610. A basic input/output system 612 (BIOS) is stored in ROM 608.

Computer system 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, BLU-RAY™ disk or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 630, one or more application programs 632, other program modules 634, and program data 636. In accordance with various embodiments, the program modules may include computer program logic that is executable by processing unit 602 to perform any or all of the functions and features of DNS server 106, any of client computing devices 102₁-102_{M}, or any of the machines in data centers 104₁-104_{M}, as described above. The program modules may also include computer program logic that, when executed by processing unit 602, performs any of the steps or operations shown or described in reference to the flowcharts of FIGS. 3-5.

A user may enter commands and information into computer system 600 through input devices such as a keyboard 638 and a pointing device 640. Other input devices (not shown) may include a microphone, joystick, game controller, scanner, or the like. In one embodiment, a touch screen is provided in conjunction with a display 644 to allow a user to provide user input via the application of a touch (as by a finger or stylus for example) to one or more points on the touch screen. These and other input devices are often connected to processing unit 602 through a serial port interface 642 that is coupled to bus 606, but may be connected by other interfaces, such as a parallel port, game port, or a universal serial bus (USB). Such interfaces may be wired or wireless interfaces.

A display 644 is also connected to bus 606 via an interface, such as a video adapter 646. In addition to display 644, computer system 600 may include other peripheral output devices (not shown) such as speakers and printers.

Computer system 600 is connected to a network 648 (e.g., a local area network or wide area network such as the Internet) through a network interface or adapter 650, a modem 652, or other suitable means for establishing communications over the network. Modem 652, which may be internal or external, is connected to bus 606 via serial port interface 642.

As used herein, the terms “computer program medium,” “computer-readable medium,” and “computer-readable storage medium” are used to generally refer to memory devices or storage structures such as the hard disk associated with hard disk drive 614, removable magnetic disk 618, removable optical disk 622, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 632 and other program modules 634) may be stored on the hard disk, magnetic disk, optical disk, ROM, or RAM. Such computer programs may also be received via network interface 650, serial port interface 642, or any other interface type. Such computer programs, when executed or loaded by an application, enable computer system 600 to implement features of embodiments of the present invention discussed herein. Accordingly, such computer programs represent controllers of computer system 600.

Embodiments are also directed to computer program products comprising software stored on any computer usable medium. Such software, when executed in one or more data processing devices, causes a data processing device(s) to operate as described herein. Embodiments of the present invention employ any computer-usable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, computer system 600 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### IV. Additional Exemplary Embodiments

A load-balancing method that is performed by a DNS server executing on a processor-based computing device is described herein. The method includes: receiving a plurality of DNS queries, each DNS query including a domain name to be resolved; determining a geolocation associated with the plurality of DNS queries; determining a time of day associated with the plurality of DNS queries; obtaining a domain name resolution policy that is associated with at least the geolocation and the time of day, the domain name resolution policy specifying a plurality of geographically disparate data centers and a ratio by which domain names are to be resolved to the plurality of geographically disparate data centers, the ratio at least specifying that more domain names are to be resolved to one of the plurality of geographically disparate data centers than another; and applying the domain name resolution policy to resolve the domain names included in the plurality of DNS queries.

In an embodiment of the foregoing method, resolving the domain names included in the plurality of DNS queries comprises resolving each of the domain names included in the plurality of DNS queries to an IP address associated with one of the plurality of geographically disparate data centers.

In another embodiment, the foregoing method further comprises sending DNS responses to each of the plurality of DNS queries, each DNS response including the IP address to which the domain name included in the corresponding DNS query was resolved.

In yet another embodiment of the foregoing method, determining the geolocation associated with the plurality of DNS queries comprises, for each DNS query: determining a source IP address of a UDP packet or TCP packet that encapsulates the DNS query; and determining that the source IP address is contained within a set of IP addresses that are associated with the geolocation.

In still another embodiment of the foregoing method, determining the geolocation associated with the plurality of DNS queries comprises, for each DNS query: obtaining geolocation information from a source of the DNS query.

In a further embodiment of the foregoing method, determining a time of day associated with the plurality of DNS queries comprises, for each DNS query: determining a time of day that the DNS query was incident upon the DNS server.

In a still further embodiment of the foregoing method, obtaining the domain name resolution policy that is associated with at least the geolocation and the time of day comprises obtaining a domain name resolution policy that is associated with the geolocation, the time of day, and one or more of: a Fully Qualified Domain Name; a Transport Protocol; an Internet Protocol; a server network interface; and a query type.

In an additional embodiment, the foregoing method further comprises receiving the domain name resolution policy via a policy configuration interface; and storing the domain name resolution policy on the processor-based computing device. In further accordance with such an embodiment, storing the domain name resolution policy on the processor-based computing device comprises performing at least one of: storing the domain name resolution policy in a data structure of a process associated with the DNS server; or storing the domain name resolution policy in an operating system registry that is persistently stored by the processor-based computing device.

A system is also described herein. The system includes at least one processor and a memory that stores computer program logic for execution by the at least one processor. The computer program logic includes one or more components configured to perform operations when executed by the at least one processor. The one or more components include a DNS server. The DNS server includes DNS query receiving logic, DNS policy matching logic, and DNS policy application logic. The DNS query receiving logic is configured to receiving a plurality of DNS queries, each DNS query including a domain name to be resolved. The policy matching logic is configured to determine a geolocation associated with the plurality of DNS queries, determine a time of day associated with the plurality of DNS queries, and obtain a domain name resolution policy that is associated with one or more of the geolocation and the time of day. The domain name resolution policy specifies a plurality of geographically disparate data centers and a ratio by which domain names are to be resolved to the plurality of geographically disparate data centers. The ratio at least specifies that more domain names are to be resolved to one of the plurality of geographically disparate data centers than another. The policy application logic is configured to apply the domain name resolution policy to resolve the domain names included in the plurality of DNS queries.

In one embodiment of the foregoing system, the policy application logic is configured to resolve the domain names included in the plurality of DNS queries by resolving each of the domain names included in the plurality of DNS queries to an IP address associated with one of the plurality of geographically disparate data centers.

In another embodiment of the foregoing system, the DNS server further comprises DNS query response logic that is configured to send DNS responses to each of the plurality of DNS queries. Each DNS response includes the IP address to which the domain name included in the corresponding DNS query was resolved.

In yet another embodiment of the foregoing system, the policy matching logic is configured to determine the geolocation associated with the plurality of DNS queries by, for each DNS query: determining a source IP address of a UDP packet or TCP packet that encapsulates the DNS query; and determining that the source IP address is contained within a set of IP addresses that are associated with the geolocation.

In still another embodiment of the foregoing system, the policy matching logic is configured to determine the geolocation associated with the plurality of DNS queries by, for each DNS query: obtaining geolocation information from a source of the DNS query.

In a further embodiment of the foregoing system, the policy matching logic is configured to determine the time of day associated with the plurality of DNS queries by, for each DNS query: determining a time of day that the DNS query was incident upon the DNS server.

In a still further embodiment of the foregoing system, the policy matching logic is configured to obtain the domain name resolution policy that is associated with one or more of the geolocation and the time of day by obtaining a domain name resolution policy that is associated with one or more of the geolocation and the time of day and one or more of: a Fully Qualified Domain Name; a Transport Protocol; an Internet Protocol; a server network interface; and a query type.

In an additional embodiment of the foregoing system, the DNS server further comprises a policy configuration interface that is configured to receive the domain name resolution policy and store the domain name resolution policy in the memory. In further accordance with such an embodiment, the policy configuration interface is configured to store the domain name resolution policy in the memory by performing at least one of: storing the domain name resolution policy as part of a process associated with the DNS server; or storing the domain name resolution policy in an operating system registry that is persistently stored in the memory.

A computer program product is also described herein. The computer program product comprises a computer-readable memory having computer program logic recorded thereon that when executed by at least one processor causes the at least one processor to perform a method comprising: providing an interface by which a user specifies a domain name resolution policy and providing the domain name resolution policy specified by the user via the interface to a DNS server for implementation thereby. Specifying the domain name resolution policy comprises at least: specifying a geolocation; specifying a time of day; specifying a plurality of geographically-disparate data centers; and specifying a ratio by which domain names in DNS queries that originate from the geolocation and that are incident upon a DNS server during the time of day are to be resolved to the plurality of geographically disparate data centers. The ratio at least specifies that more domain names are to be resolved to one of the plurality of geographically disparate data centers than another.

In one embodiment of the foregoing computer program product, specifying the domain name resolution policy further comprises specifying one or more of a Fully Qualified Domain Name; a Transport Protocol; an Internet Protocol; a server network interface; and a query type. Each of the Fully Qualified Domain Name, the Transport Protocol, the Internet Protocol, the server network interface and the DNS query type further defines the type of DNS queries to which the DNS name resolution policy is to be applied.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A load-balancing method performed by a Domain Name System (DNS) server executing on a processor-based computing device, comprising:
receiving a plurality of DNS queries, each DNS query including a domain name to be resolved;
determining a geolocation associated with the plurality of DNS queries;
determining a time of day associated with the plurality of DNS queries;
obtaining a domain name resolution policy that is associated with at least the geolocation and the time of day, the domain name resolution policy specifying a plurality of geographically disparate data centers and a ratio by which domain names are to be resolved to the plurality of geographically disparate data centers, the ratio at least specifying that more domain names are to be resolved to one of the plurality of geographically disparate data centers than another; and
applying the domain name resolution policy to resolve the domain names included in the plurality of DNS queries.

2. The method of claim 1, wherein resolving the domain names included in the plurality of DNS queries comprises:
resolving each of the domain names included in the plurality of DNS queries to an Internet Protocol (IP) address associated with one of the plurality of geographically disparate data centers.

3. The method of claim 2, further comprising:
sending DNS responses to each of the plurality of DNS queries, each DNS response including the IP address to which the domain name included in the corresponding DNS query was resolved.

4. The method of claim 1, wherein determining the geolocation associated with the plurality of DNS queries comprises, for each DNS query:
determining a source Internet Protocol (IP) address of a User Datagram Protocol (UDP) packet or Transmission Control Protocol (TCP) packet that encapsulates the DNS query; and
determining that the source IP address is contained within a set of IP addresses that are associated with the geolocation.

5. The method of claim 1, wherein determining the geolocation associated with the plurality of DNS queries comprises, for each DNS query:
obtaining geolocation information from a source of the DNS query.

6. The method of claim 1, wherein determining a time of day associated with the plurality of DNS queries comprises, for each DNS query:
determining a time of day that the DNS query was incident upon the DNS server.

7. The method of claim 1, wherein obtaining the domain name resolution policy that is associated with at least the geolocation and the time of day comprises obtaining a domain name resolution policy that is associated with the geolocation, the time of day, and one or more of:
a Fully Qualified Domain Name;
a Transport Protocol;
an Internet Protocol;
a server network interface; and
a query type.

8. The method of claim 1, further comprising:
receiving the domain name resolution policy via a policy configuration interface; and
storing the domain name resolution policy on the processor-based computing device.

9. The method of claim 8, wherein storing the domain name resolution policy on the processor-based computing device comprises performing at least one of:
storing the domain name resolution policy in a data structure of a process associated with the DNS server; or
storing the domain name resolution policy in an operating system registry that is persistently stored by the processor-based computing device.

10. A system comprising:
at least one processor; and
a memory that stores computer program logic for execution by the at least one processor, the computer program logic including one or more components configured to perform operations when executed by the at least one processor, the one or more components including a DNS server, the DNS server comprising:
DNS query receiving logic that is configured to receiving a plurality of DNS queries, each DNS query including a domain name to be resolved;
policy matching logic that is configured to determine a geolocation associated with the plurality of DNS queries, determine a time of day associated with the plurality of DNS queries, and obtain a domain name resolution policy that is associated with one or more of the geolocation and the time of day, the domain name resolution policy specifying a plurality of geographically disparate data centers and a ratio by which domain names are to be resolved to the plurality of geographically disparate data centers, the ratio at least specifying that more domain names are to be resolved to one of the plurality of geographically disparate data centers than another; and
policy application logic that is configured to apply the domain name resolution policy to resolve the domain names included in the plurality of DNS queries.

11. The system of claim 10, wherein the policy application logic is configured to resolve the domain names included in the plurality of DNS queries by:
resolving each of the domain names included in the plurality of DNS queries to an Internet Protocol (IP) address associated with one of the plurality of geographically disparate data centers.

12. The system of claim 11, wherein the DNS server further comprises DNS query response logic that is configured to send DNS responses to each of the plurality of DNS queries, each DNS response including the IP address to which the domain name included in the corresponding DNS query was resolved.

13. The system of claim 10, wherein the policy matching logic is configured to determine the geolocation associated with the plurality of DNS queries by, for each DNS query:
determining a source Internet Protocol (IP) address of a User Datagram Protocol (UDP) packet or Transmission Control Protocol (TCP) packet that encapsulates the DNS query; and
determining that the source IP address is contained within a set of IP addresses that are associated with the geolocation.

14. The system of claim 10, wherein the policy matching logic is configured to determine the geolocation associated with the plurality of DNS queries by, for each DNS query:
obtaining geolocation information from a source of the DNS query.

15. The system of claim 10, wherein the policy matching logic is configured to determine the time of day associated with the plurality of DNS queries by, for each DNS query:
determining a time of day that the DNS query was incident upon the DNS server.

16. The system of claim 10, wherein the policy matching logic is configured to obtain the domain name resolution policy that is associated with one or more of the geolocation and the time of day by obtaining a domain name resolution policy that is associated with one or more of the geolocation and the time of day and one or more of:
a Fully Qualified Domain Name;
a Transport Protocol;
an Internet Protocol;
a server network interface; and
a query type.

17. The system of claim 10, wherein the DNS server further comprises a policy configuration interface that is configured to receive the domain name resolution policy and store the domain name resolution policy in the memory.

18. The system of claim 17, wherein the policy configuration interface is configured to store the domain name resolution policy in the memory by performing at least one of:
storing the domain name resolution policy as part of a process associated with the DNS server; or
storing the domain name resolution policy in an operating system registry that is persistently stored in the memory.

19. A computer program product comprising a computer-readable memory having computer program logic recorded thereon that when executed by at least one processor causes the at least one processor to perform a method comprising:
providing an interface by which a user specifies a domain name resolution policy, wherein specifying the domain name resolution policy comprises at least:
specifying a geolocation;
specifying a time of day;
specifying a plurality of geographically-disparate data centers; and
specifying a ratio by which domain names in DNS queries that originate from the geolocation and that are incident upon a DNS server during the time of day are to be resolved to the plurality of geographically disparate data centers, the ratio at least specifying that more domain names are to be resolved to one of the plurality of geographically disparate data centers than another; and
providing the domain name resolution policy specified by the user via the interface to a DNS server for implementation thereby.

20. The computer program product of claim 19, wherein specifying the domain name resolution policy further comprises specifying one or more of:
a Fully Qualified Domain Name;
a Transport Protocol;
an Internet Protocol;
a server network interface; and
a query type;
wherein each of the Fully Qualified Domain Name, the Transport Protocol, the Internet Protocol, the server network interface and the DNS query type further defines the type of DNS queries to which the DNS name resolution policy is to be applied.
